(19) United States
(12) Patent Application Publication
(10) Pub. No.: US 2007/0242708 A1
(43) Pub. Date: Oct. 18, 2007

(54) Method for Designing a Semiconductor Laser with Intracavity Reflecting Features, Semiconductor Laser Method of Fabrication Thereof

(75) Inventors: Stephen O'Brien, Cork (IE); Eoin Patrick O'Reilly, County Cork (IE)

Correspondence Address: JACOBSON HOLMAN PLLC, 400 SEVENTH STREET N.W., SUITE 600, WASHINGTON, DC, 20004, US

(73) Assignee: UNIVERSITY COLLEGE CORK-NATIONAL UNIVERSITY OF IRE, Cork (IE)

(21) Appl. No.: 11/632,310

(22) PCT Filed: Jul. 18, 2005
(86) PCT No.: PCT/IE05/00075

§ 371 Date: Jan. 12, 2007

(30) Foreign Application Priority Data
Jul. 16, 2004 (IE) 2004/0484
Apr. 26, 2005 (IE) 2005/0253

(51) Int. Cl. H01S 3/10

(52) U.S. Cl. 372/26

(57) ABSTRACT

A Fabry-Pérot (FP) laser device (1) has an n-type substrate (2), an active region (3), a p-type cladding (4), an insulator (5), and a contact (6). The cladding (4) comprises a ridge (7) having a number of slots (8). The slots (8) cause a partial longitudinal reflection of the light. The precise locations of the slots are chosen to accurately and predictably achieve a particular selected mode or modes in the output light. A method to design a slot pattern both preferentially selects a particular Fabry-Pérot mode as the peak emission wavelength and also suppresses an arbitrary number of neighbouring Fabry-Pérot modes. The method selects a set of Fabry-Pérot modes in preference to other Fabry-Pérot modes within the cavity. In this way the method addresses the important problems for semiconductor lasers of predetermination of the peak lasing wavelength and also stability of the peak lasing mode with changes in temperature. The method also allows for the fabrication of multimode devices with increased functionality both as individual devices and as component parts of more complex multi-section or multi-element devices.

### INTRODUCTION

1. Field of the Invention

The invention relates to semiconductor lasers, particularly those of the edge-emitting Fabry-Pérot type and to their design and manufacture.

2. Prior Art Discussion

Semiconductor laser light emitting devices comprise a waveguide, which is formed by the semiconductor wafer structure in which the laser light is generated. Semiconductor ridge waveguide Fabry-Pérot (FP) lasers have the advantage of being relatively straightforward to manufacture but suffer from the drawback that the lasers tend to operate multimode. A number of different routes have therefore been pursued to achieve one or more discrete-modes with neighbouring wavelengths suppressed.

It is known that defects or perturbations within the cavity can introduce a modulation, which can improve the spectral purity of the Fabry-Pérot laser. Following from this principle, quasi single-moded edge-emitting FP lasers have been demonstrated using a variety of techniques. Small absorptive sites have been created along the laser cavity using high energy laser pulses (L. F. diChiaro, J. Lightwave Tech., 9(8) (1991) p. 975). Side mode suppression (SMS) better than 20 dB was achieved using as few as three such sites. An undesirable feature of this technique, however, is the large increase in the device threshold current which can accompany the introduction of the lossy regions.

An alternative technique involves the creation of reflective or scattering sites along the cavity of the laser by focused ion beam etching (D. A. Kozlowski, J. S. Young, J. M. C. England and R. G. S. Plumb, IEE Electron. Lett., 31(8) (1995) p. 648). For positioning, a similar scheme to that of diChiaro was employed; N sites are nominally located at distances of L_{cav}/2ⁿ, n=1, . . . , N. from one of the cleaved facets and where L_{cav} is cavity length. In this case SMS as large as 30 dB was achieved with three etch sites and with a minor increase in the device threshold current.

A coupled cavity laser design has also been proposed (H. Naito, H. Nagai, M. Yuri, K. Takeoka, M, Kume, K. Hamada and H. Shimizu, J. Appl. Phys., vol. 66, (1989) p. 5726). Two waveguide cores are connected within the cavity and, owing to the internal reflection due to the change in the effective index, a modulated effective reflectivity could be ascribed to one of the facets. While these devices possess desirable features, multiple growth and etching steps are necessary to form the structure.

Numerical techniques have also been used to design distributions of effective index and injected current in order to achieve improved spectral purity in edge emitting lasers. These include the use of genetic breeder algorithms (D. Erni, M. M. Spuhler and J. Frölich, Opt. Quant. Electron., 30, (1998) p. 287).

A technique which does not require additional processing or regrowth steps involves the creation of a low density of additional features in the laser ridge waveguide at the lithographic and etching stages when the ridge itself is formed (B. Corbett and D. McDonald, IEE Electron. Lett., 31(25) (1995) p. 2181). These features are typically made as small as 1 μm in length and can have a primarily reflective character. In the case of ridge waveguide semiconductor lasers emitting near 1.5 μm wavelength, the additional features resemble slots, which penetrate into the cladding region of the optical waveguide of the laser.

The invention is directed towards achieving more controlled production of Fabry-Pérot laser devices so that one or more output modes are accurately achieved.

### SUMMARY OF THE INVENTION

According to the invention, there is provided a method for designing an edge-emitting semiconductor laser device comprising a Fabry-Pérot laser cavity with mirrors for regenerative feedback for lasing, and at least one feature in the cladding between the cavity mirrors, each feature causing a local change in refractive index, wherein the method comprises the steps of determining the locations of the features based on a relationship between feedback in sub-cavities between each feature and a cavity mirror and modulation of the threshold gain of the Fabry-Pérot modes of the cavity.

In one embodiment, the method comprises the step of generating a feature density function.

In another embodiment, the feature density function is generated by multiplying the threshold modulation amplitude expression by the Fourier transform of the desired threshold gain modulation function, said feature density function being:
[|r₁|exp[εL_{cav}αₘᵢᵣ]−|r₂|exp[−εL_{cav}αₘᵢᵣ]]⁻¹|F(ε)|,
in which,

the gain is distributed uniformly along the length of the cavity,

$${α}_{mir} = \frac{1}{{L}_{cav}} log \frac{1}{\vert {r}_{1} {r}_{2} \vert}$$

are the mirror losses of an unperturbed cavity,
L_{cav} is the cavity length,
r₁ and r₂ are the mirror reflectivities
F(ε) is the Fourier transform of the threshold modulation function, and
ε=n− 1/2.

In a further embodiment, the Fourier transform has positive and negative components, the positive and negative components give rise to slot positions located at even integer plus one half and odd integer plus one half multiples of the values of the quarter wavelength of light emitted at the selected mode m₀ with respect to one of the cavity mirrors and there are multiple modes in the laser spectrum.

In one embodiment, the method comprises the further step of uniformly sampling the feature density function.

In another embodiment, the sampling is determined by the total number of features to be introduced.

In a further embodiment, the sampling is performed according to the expression:

$$A {\sum }_{n} {\int }_{{∈}_{min}}^{{∈}_{j}} {[ \begin{matrix}\vert {r}_{1} \vert exp [ ∈ {L}_{cav} {α}_{mir} ] - \\ \vert {r}_{2} \vert exp [ - ∈ {L}_{cav} {α}_{mir} ]\end{matrix} ]}^{- 1} Γ ( x - n / a ) ⅆ x = j \sim 1 / 2$$

in which the normalisation constant A is determined by the number of features to be introduced, which must be specified in order to sample the feature density function.

In one embodiment, the method comprises the further steps of adjusting feature positions indicated by the sampling, to optimise resonant feedback magnitude.

In another embodiment, the feature positions are adjusted so that for each feature, a short sub-cavity on one side has a length which is a multiple of an odd integer number of quarter wavelengths of the selected mode m₀, and the longer sub-cavity on the other side has a length which is a multiple of an even integer number of quarter wavelengths of the selected mode, provided that the change is the effective index due to a feature is negative, the mirror reflectivities are real and positive numbers, and single mode operation is desired.

In a further embodiment, the features are slots in the cladding.

In one embodiment, the slots are in a cladding ridge.

In another aspect, the invention provides a method of manufacturing an edge-emitting semiconductor laser device comprising a Fabry-Pérot laser cavity with mirrors for regenerative feedback for lasing, the method comprising the steps of:
designing the device in any method as defined above, and
fabricating the device with provision of slots in a cavity ridge during lithographic and etching stages of forming the ridge.

In one embodiment, the device is designed in a method as defined above, and the device is a multi-mode laser device.

In another aspect the invention provides an edge-emitting semiconductor laser device comprising a Fabry-Pérot laser cavity with mirrors for regenerative feedback for lasing, and at least one feature in the cladding between the cavity mirrors, said feature or features being located according to any design method set out above.

### DETAILED DESCRIPTION OF THE INVENTION

### Brief Description of the Drawings

The invention will be more clearly understood from the following description of some embodiments thereof given by way of example only with reference to the accompanying drawings, in which:

FIG. 1(a) is a schematic diagram of a Fabry-Pérot laser device having slots in a cladding ridge, FIG. 1(b) is a flow diagram for design of the device and FIG. 1(c) is a graphical representation of the step 21 of FIG. 1(b);

FIG. 2 is a one dimensional model of the cavity of a laser device;

FIG. 3 is a plot of threshold gain of a homogeneous Fabry-Pérot laser as a function of cavity mode index m, in which the threshold gain is taken to be constant in this example;

FIG. 4 is a schematic diagram of another laser structure which is optimally slotted for mode selection according to the present invention;

FIG. 5(a) is a plot of threshold gain distribution of an unperturbed Fabry-Pérot laser, in which the variation of the semiconductor gain function, γ(λ₀), with wavelength is also shown, and FIG. 5(b) shows threshold gain distribution of a perturbed Fabry-Pérot laser where a single mode at m₀ is selected;

FIG. 6 is a plot of threshold gain distribution of a perturbed Fabry-Pérot laser device where a comb of modes at m₀±na is selected, n being an integer;

FIG. 7 is a plot of threshold gain distribution of a perturbed Fabry-Pérot laser where the losses are reduced at mode m₀, with a weaker loss reduction at m₀±na, and with other modes being largely unaffected by the perturbations introduced;

FIG. 8 is a plot of threshold gain for the laser cavity with sixteen slots described in Table 1;

FIG. 9 is a plot of below threshold SMSR and peak mode position with temperature of the device of FIG. 8;

FIG. 10(a) is a plot of an optimum slot density distribution function of a laser device, in which the inset is a diagram of a laser cavity with a slot pattern determined according to the invention; and FIG. 10(b) is a plot of the form of the resultant threshold gain spectrum of this laser;

FIG. 11 is a plot of the lasing spectrum at twice threshold of a single mode laser of FIG. 10, and the inset is the lasing spectrum at twice threshold of a Fabry-Pérot laser without slots, for reference purposes;

FIG. 12 is a plot of the form of the threshold gain of modes for a laser cavity where two Fabry-Pérot modes at predetermined wavelengths are selected, and the inset is a schematic diagram of the laser cavity ridge;

FIG. 13 is a plot of the form of the threshold gain of modes for a laser cavity for which three Fabry-Pérot modes are selected;

FIG. 14 is a plot of threshold gain for a laser cavity with twenty slots described in Table 2;

FIG. 15 is a diagram of a multi-section device incorporating two slotted FP structures designed according to the present invention; and

FIG. 16 is a diagram of a multi-section device in which slotted FP structures are laterally coupled and each section is independently contacted, such devices allowing for increased power output in a single mode and for increased modulation bandwidth.

### DETAILED DESCRIPTION OF THE INVENTION

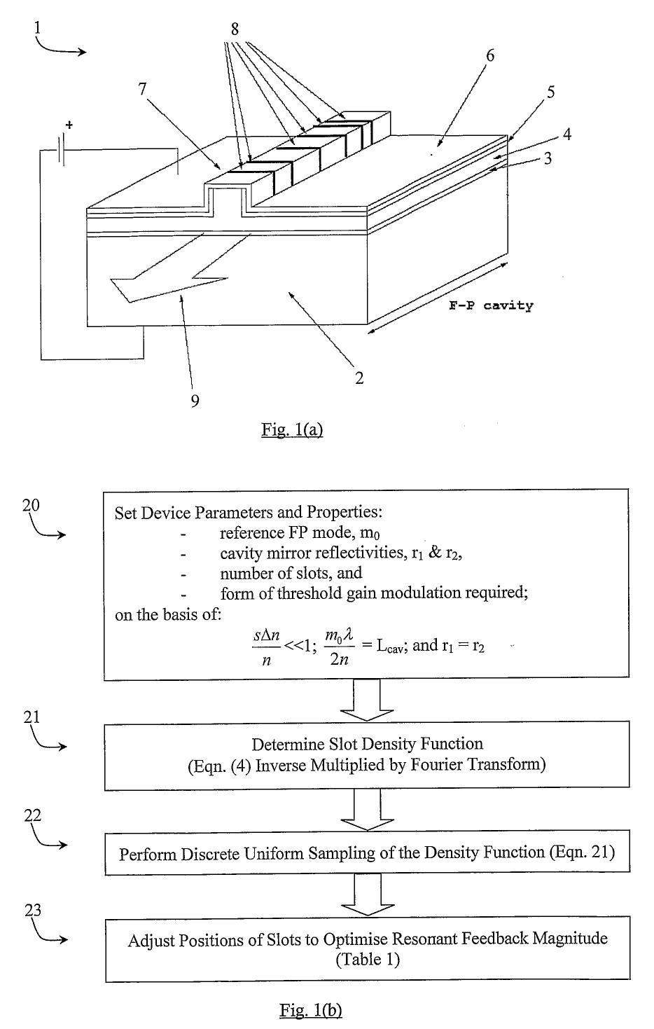

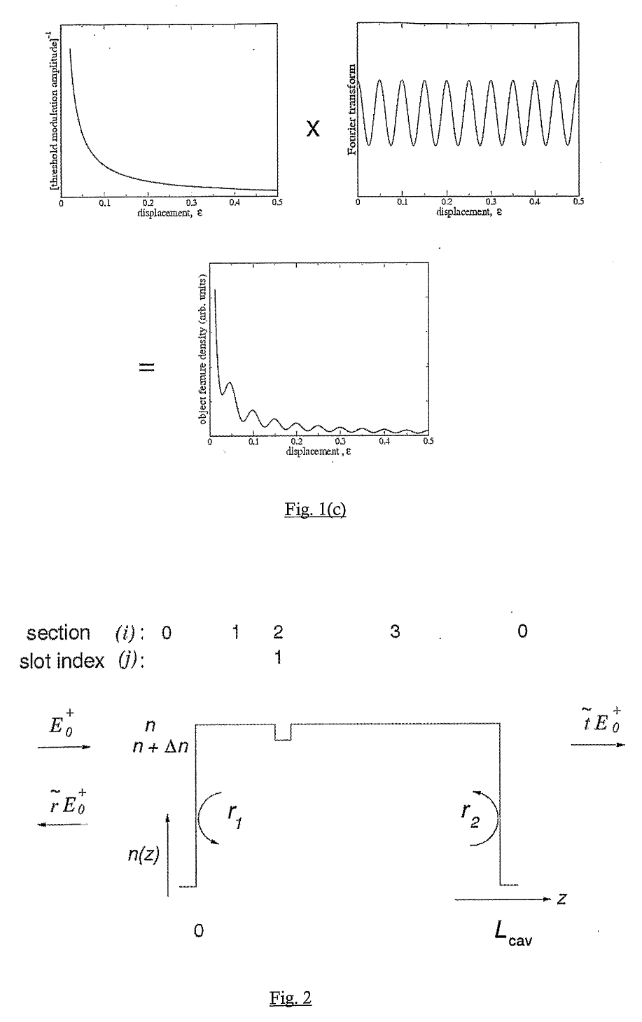

Referring to FIG. 1(a) a Fabry-Pérot (FP) laser device 1 has an n-type substrate 2, an active region 3, a p-type cladding 4, an insulator 5, and a contact 6. The cladding 4 comprises a ridge 7 having a number of slots 8. The light emitting direction is shown by the arrow 9.

In the device 1, the primary sources of optical feedback are the as-cleaved cavity mirrors. The structure is grown epitaxially on a substrate. The active region operates under forward bias to generate light. Confinement layers serve to provide electronic confinement for the carriers trapped in the active region. The light comes out through the cavity mirrors. The active region placed within the confinement layer is preferably formed by any insertion, the energy band of which is narrower than that of the substrate. Possible active regions include, but are not limited to, a single quantum well or a multi-layer system of quantum wells, quantum wires, quantum dots, or any combination thereof.

The slots 8 cause a partial longitudinal reflection of the light. In the invention the precise location of the slots is chosen to accurately and predictably achieve a particular selected mode or modes in the output light.

Device Design Method Overview

Referring to FIG. 1(b) a method of designing a laser device such as the device 1 is illustrated. The invention provides a method to design a slot pattern in a laser device, both to preferentially select a particular Fabry-Pérot mode as the peak emission wavelength and also to suppress an arbitrary number of neighbouring Fabry-Pérot modes. The method selects a set of Fabry-Pérot modes in preference to other Fabry-Pérot modes within the cavity. In this way the method addresses the important problems for semiconductor lasers of predetermination of the peak lasing wavelength and also stability of the peak lasing mode with changes in temperature. The method also allows for the fabrication of multimode devices with increased functionality both as individual devices and as component parts of more complex multi-section or multi-element devices.

In a step 20 device parameters and properties are set. These include reference FP mode m₀, cavity mirror reflectivities r₁ and r₂, the number of slots, and form of threshold gain modulation required. These parameters are set on the basis of:

$$\frac{s Δ n}{n} << 1 ; \frac{{m}_{0} λ}{2 n} = {L}_{cav} ; and {r}_{1} = {r}_{2}$$

where
n is the refractive index,
Δn is the local change in refractive index caused by a slot,
λ is the emission wavelength of mode m₀,
L_{cav} is the cavity length, and
r₁, r₂ are the cavity mirror reflectivities (ends cleaved and un-treated).

It is to be noted that the mirror reflectivities r₁ and r₂ are equal, real, and positive. The data for step 20 is inputted manually, and the remaining steps of the method are implemented automatically by computer.

In step 21a slot density function is automatically determined, as set out in more detail below (particularly Eqn. (4)). This is represented graphically in FIG. 1(c), which is a single mode example for which the parameters are a=20, τ=0.036 and |r₁|=|r₂|.

In step 22 the slot density function is sampled, again as set out in more detail below (particularly Eqn. (21)).

Finally, in step 23 the position of the slots are adjusted to optimize resonant feedback magnitude, as set out in more detail below with reference to Table 1 particularly.

Referring to FIG. 2 a model of a Fabry-Pérot laser is shown. The cavity is of length L_{cav} and includes s slots. The cavity effective index is n and the slot region has effective index n+Δn. The cavity is in vacuum with all cavity sections numbered i beginning on the left. The slots are also numbered with index j. The complex transmission and reflection coefficients of the cavity are \tilde{t} and \tilde{r} respectively.

Sub-cavities

In a Fabry-Pérot laser, the cavity mirrors are the sources of regenerative feedback necessary for lasing oscillation. The addition of a perturbation (in this embodiment a slot) to the FP cavity forms two sub-cavities between the slot and the cavity mirrors as illustrated in FIG. 2. The slot perturbs the effective refractive index experienced by an optical mode propagating in the cavity. The numerical value of this effective index step is Δn. Optical modes of the cavity undergo a partial reflection at the boundaries between the cavity and the slotted region. This partial reflection gives rise to additional feedback and is the origin of the optical mode selectivity.

In the method of the invention each slot location is selected with consideration of the sub-cavities on each side between the slot and the cavity mirrors. This consideration is made irrespective of other slots (other than minor path length corrections), the parameter values for the sub-cavities for each slot being determined independently.

The method is based on an understanding of how the feedback from the slot modulates the threshold gain of the FP modes. These FP modes are the lasing modes of the device, and information about light at other wavelengths is unimportant.

The partial reflection provided by a slotted region comprising two parallel interfaces perpendicular to the laser ridge is maximized. Each of the reflective interfaces provides a similar amount of optical feedback and choice of the correct slot length then allows the mode selectivity due to the feedback from the slot to be maximized.

Given that the effective index step associated with the slots is small, the complex reflection coefficient of the slot, rₛ, can be approximated by a summation of the two primary reflections from the slot/cavity interfaces, ±rᵢ. The result is rₛ=rᵢ+e^{2iθ}·(−rᵢ). Here θ=nₛk₀Lₛ is the phase advance across the slot, nₛ is the effective refractive index of the slotted region, k₀ is the free space wavenumber of the cavity mode and Lₛ is the length of the slotted region. The reflection coefficient assumes its maximum value of 2rᵢ provided 2θ=(2q+1)π where q is an integer. This relation implies that Lₛ=(q+½)λ₀/2nₛ. In order to maximize the partial reflection of a given optical mode due to the slot, the length of the slotted region must therefore be an odd integer number of quarter wavelengths of the selected optical mode in question. In the following it is assumed that the slot lengths (Ls) are as above, but is can be otherwise.

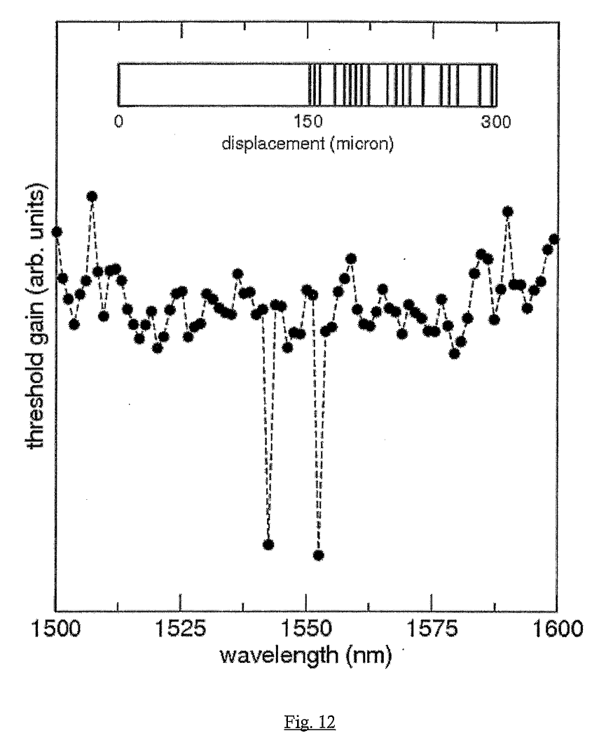

The peak mode is determined by the spacing of the slots with respect to the cavity mirrors. In general, the two sub-cavities formed by each slot have different lengths. The change in the threshold gain of the selected mode is maximized in the method. For single mode design, the selected mode is m₀, and the change in threshold gain is maximized for m₀. However, as described below with reference to FIG. 12, where two or more modes are selected m₀ may not have the largest change in threshold gain. However, m₀ is always the central mode, the selected modes being symmetrical about m₀. An important criterion, for Δn being negative, is that the long sub-cavity has a length of an integer multiple of a half wavelength of the selected mode and the short sub-cavity has a length of an odd integer multiple of a quarter wavelength of this mode. Thus, the length of the long sub-cavity is such that it is resonant with the mode selected. However, Δn may alternatively be positive if the feature is not a slot. If Δn is positive the roles of the long and short sub-cavities are reversed.

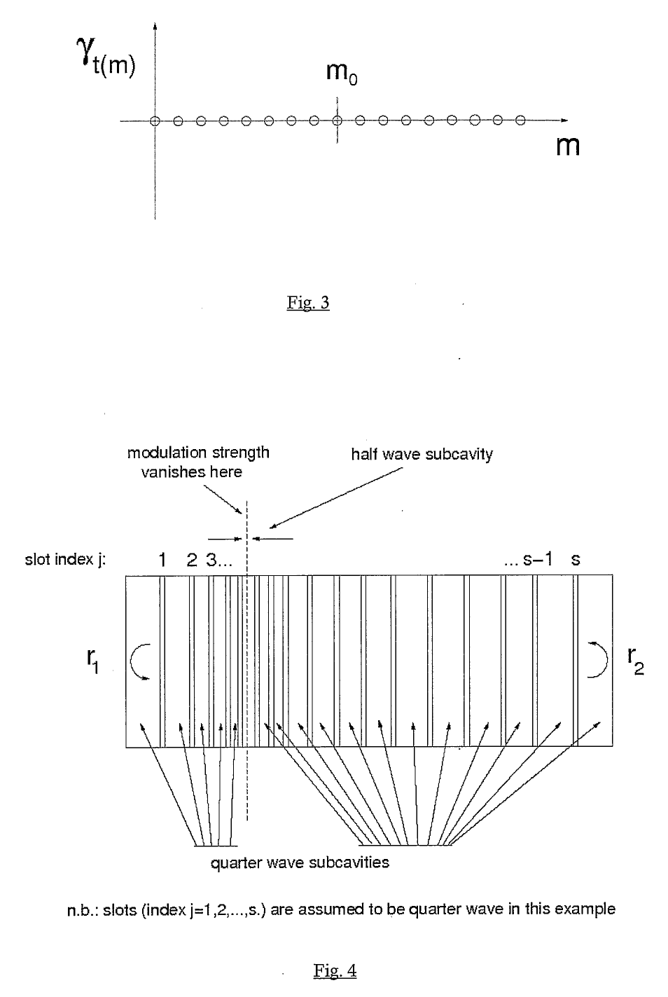

FIG. 3 illustrates the slight variation of the threshold gain of the optical modes of a homogeneous Fabry-Pérot laser as a function of cavity mode index m. In this example the threshold gain is taken to be a constant with all modes having equal losses. A homogeneous FP laser has a grid of allowed modes, with the free-space wavelength of the m^{th} mode, λₘ₀, given by
mλₘ_{₀}/2n=L_{cav} (1)

Here n is the cavity effective index and L_{cav} is the cavity length. This relation (equation 1) implies that the condition for resonance is that the cavity length must be equal to an integer number of the lasing mode half-wavelengths in the cavity. We chose a specific cavity mode (mode index m=m₀) and set the slotted region length in order to maximize the slot reflectivity for that mode. The first case considered here is the case where the cavity mirrors are as cleaved, then the change in the threshold gain for that mode will be maximized provided that one of the sub-cavities formed by the slot has a length equal to an integral number of the mode half-wavelengths in the cavity. If the slot length is as described above, then the other sub-cavity will have a length equal to an odd integer number of the mode quarter-wavelengths in the cavity. In this way the resonant nature of the feedback due to the slotted region is ensured and the change in the threshold gain of the selected mode is maximized.

Semiconductor lasers of the invention therefore incorporate slots which are placed on a discrete set of positions along the laser cavity. Where the cavity mirrors have a coating applied, or some other means of altering the as-cleaved mirror reflectivity is employed, the existence of a discrete set of points for the slot positions remains. However, the sub-cavities formed such that the threshold gain modulation is maximized may in this case no longer be as described above. The method can accommodate these cases and a suitable implementation of the method will allow for improved spectral purity and guaranteed stability of the laser output with temperature in such devices. The general case of arbitrary facet reflectivity can be described using a complex value for the facet reflectivity such that r₁=|r₁|e^{iφ}^{₁} and r₂=|r₂|e^{iφ}^{₂}.

For the case where φ₁=φ₂=0, we now establish the frequency components of the modulation of the threshold gain due to the introduction of the slots.

The cavity mirrors define the lasing modes of the cavity and the threshold gain, γₜ, with a modulation period of one cavity mode. We therefore have for the threshold gain
γₜ∝ cos(2mπ) (2)

Consider the feedback provided by the reflection due to the slots. With respect to the centre of the slotted region, and as a fraction of the cavity length, the sub-cavities formed by the slots have lengths η and (1−η) where η<1. The feedback due to the slot will therefore, in general, introduce a modulation of the threshold gain spectrum at two different frequencies.

The reflection coefficient of the slot, defined at the center of the slot is e^{-iθ}rᵢ(1−e^{2iθ})=−2irᵢ sin θ. This phase shift of ±π/2 with respect to the slot/cavity interfaces implies that the modulation of the threshold gain due to the slot reflection will be proportional to
cos(2ηmπ−π/2)+cos [2(1−η)mπ+π/2]=2 cos(mπ)sin(2εmπ). (3)

Here ε=η−½ is the position of the center of the slot measured from the cavity centre as a fraction of the cavity length. Thus the modulation of the threshold gain comprises a fast modulation at every two cavity modes times a modulation at the frequency equal to half of the difference between the frequencies of the individual modulation periods due to each sub-cavity.

Thus semiconductor lasers of the present invention include a slot pattern such that the frequency of the modulation of the threshold gain due to each slot is incorporated into the design. This enables the tailoring of the threshold gain distribution in the neighbourhood of the selected mode, m₀, and allows the construction of an effective index pattern that provides a peak mode that is stable with changing temperature.

Amplitude Selection

The position of the slot relative to the cavity mirrors determines the amplitude of the modulation of the threshold gain due to the slot. This understanding is also necessary for the construction of an effective index pattern that provides a peak mode that is stable with changing temperature.

The change in the threshold gain due to a slot is given by the difference in the amplitude gain to the left and to the right of the slot. For example, in the case where the gain is distributed uniformly along the length of the cavity, we have
Δγₜ∝rₛ|r₁|exp(ηL_{cav}αₘᵢᵣ)−rₛ|r₂|exp[(1−η)L_{cav}αₘᵢᵣ] (4)

Here

$${α}_{mir} = \frac{1}{{L}_{cav}} log \frac{1}{\vert {r}_{1} {r}_{2} \vert}$$

are the mirror losses of the unperturbed cavity. The amplitude of the modulation of the threshold gain due to a slot is therefore determined by the reflectivity of each cavity mirror and also by the proximity of the slot to each of the cavity mirrors.

Thus lasers designed according to the invention include a slot pattern such that the amplitude of the modulation of the threshold gain due to each slot is known. This understanding then allows for the choice of a set of slot positions that provides a peak mode that is stable with changing temperature.

The complete expression for the dependence of the threshold gain modulation due to each slot in the case where φ₁=φ₂=0 is then given by
Δγₜ∝rᵢ sin θ{|r₁|exp(ηL_{cav}αₘᵢᵣ)−|r₂|exp[(1−η)L_{cav}αₘᵢᵣ]}×cos(mπ)sin(2εmπ) (5)

Expression (5) includes components arising from parameters of slot length (sinθ), lengths of the sub-cavities (η and (1−η), amplitude variation (within { }), and frequency of the output light (m). It implies that there may in general be a position along the cavity where the modulation of the cavity modes due to the slotted region will vanish. For example, where the cavity mirrors have equal reflectivities, and the gain is distributed uniformly along the device, this position coincides with the device centre. The term in expression (5), which determines the modulation strength, |r₁|exp[ηL_{cav}αₘᵢᵣ]−|r₂|exp[(1−η)L_{cav}αₘᵢᵣ], will change in sign as this position is traversed. Where the point where the modulation strength vanishes lies between the cavity mirrors, and where the objective of the placement of the slots is the single mode operation of the laser, this change in sign requires the introduction of a π/2 phase shift into the slot pattern. Thus it is appreciated that in this case pairs of slotted regions placed on either side of this position may be separated by sub-cavities of length equal to an integral number of cavity half wavelengths of the selected mode. Pairs of slotted regions placed on the same side of the device with respect to this point are separated by sub-cavities of lengths equal to an odd integer number of cavity quarter wavelengths of the selected mode. In the case of an optimal device where φ₁=φ₂=0 and where the slot length is such that the reflection due to the slot is maximized, this property of the slot pattern appropriate to the single mode operation is then a fundamental property.

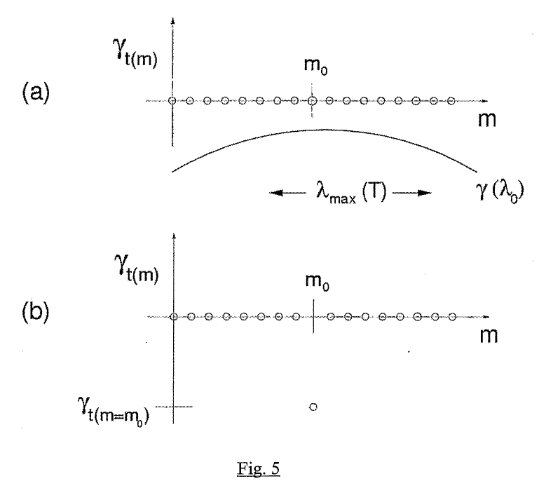

A schematic diagram of such an optimized structure is shown in FIG. 4. In this example the mirror reflectivities r₁ and r₂ are taken to be real and positive numbers. It is also assumed that Δn sin θ<0, where θ is the phase advance across the slot, and r₁>r₂. The vertical dotted line coincides with the point where the modulation of the threshold gain of the cavity modes due to a slot vanishes. Sub-cavities formed by the slots and the slots themselves are quarter wave and half wave in the sense above. In this example we have taken r₁>r₂ which results in the point where the modulation strength vanishes moving toward the left mirror, i.e. the mirror with the larger reflectivity.

The above demonstrates that an understanding of the effect of a slot on the threshold gain spectrum of the device can be used to tailor the threshold gain spectrum of the device to a degree such that the spectral purity of the device is improved at a predetermined wavelength and the stability of the peak mode with changing temperature can be guaranteed.

We label our selected mode, to have a minimum threshold gain, as m₀ in the single-moded case, and in general as m₀+Δm. The threshold gain modulation can be expressed in the following form, assuming the positioning of slots for resonant feedback as in FIG. 4:
Δγₜ(m₀+Δm)∝ cos(mπ)sin(2εmπ)=cos(m₀π)sin(2εm₀π)cos(Δmπ)cos(2εΔmπ) (6)

The threshold gain modulation of the cavity modes defined by their separation Δm from the selected mode can therefore be represented as a cosine series where the frequency of the modulation is determined by the distance of the slot from the device centre. The requirement that the slots be placed only on the discrete set of allowed points as determined by the mirror reflectivities and the gain distribution along the cavity is necessary for the validity of this representation. In the case considered where φ₁=φ₂=0, and neglecting the optical path length corrections due to the slots themselves, these allowed points are defined by the relations sin(2εⱼm₀π)=±1 where εⱼ=ηⱼ−½.

The method designs a slot pattern based on the understanding of the effect of a slot on the threshold gain as described by expression (5) above. Using the above expression, or similar expressions for the case where φ₁≠φ₂, an explicit link with the techniques of Fourier analysis can be made. Thus the method designs a slot pattern (step 21) along the cavity in order to approximately construct the desired threshold gain modulation.

The perturbation is treated as a separate macroscopic section of the laser cavity where, according to the transverse structure, we assign a different effective index. Each section of the laser is assumed to have a square well profile. In the case of a one-dimensional model of a FP laser cavity of length L_{cav} and including a single slot region the complex transmission of the cavity can be found by considering a matrix product. Since typically, Δn/n<<1, where n is the cavity effective index, we can treat the influence of the slot by only retaining terms to order Δn/n in the matrix product. The complex transmission coefficient of a cavity containing a single defect is then given by

$$\tilde{t} = \frac{{t}_{1} {t}_{2} exp ( {ⅈΣθ}_{i} )}{1 - {r}_{1} {r}_{2} exp ( 2 {ⅈθ}_{i} )} \cdot {\{ 1 - ⅈ \frac{Δ n}{n} {Σ}_{j} sin ( {θ}_{j} ) \frac{{r}_{1} exp ( 2 {ⅈϕ}_{j}^{-} ) + {r}_{2} exp ( 2 {ⅈϕ}_{j}^{+} )}{1 - {r}_{1} {r}_{2} exp ( 2 {ⅈΣθ}_{i} )} \}}^{- 1} , \qquad ( 7 )$$

In equation 7 above, θᵢ=k_{iz}·Lᵢ with k_{iz}=nᵢk_{0z} and Lᵢ is the length of the i^{th} section. As indicated in FIG. 2, the reflectivity of the left mirror is r₁ and the reflectivity of the right mirror is r₂. The transmission coefficients at these mirrors are t₁ and t₂ respectively. For the case of a real refractive index distribution, the quantities φⱼ⁻ and φⱼ⁺ are the optical path lengths from the center of slot j to the left and right facets respectively.

We assume that the effective index step is the same for all the additional slots. For a laser incorporating s slots (index j) and with the cavity defined between −L_{cav}/2 and +L_{cav}/2, one can show that the change in threshold gain of the m^{th} mode is given by, to first order in Δn/n:

$$Δ {γ}_{t ( m )} = \frac{1}{{L}_{cav} \sqrt{\vert {r}_{1} {r}_{2} \vert}} \times {Σ}_{j} {a}_{j ( m )} \{ \begin{matrix}\vert {r}_{1} \vert exp ( {∈}_{j} L {α}_{mir} ) - \\ \vert {r}_{2} \vert exp ( - {∈}_{j} L {α}_{mir} )\end{matrix} \} , \\ where \\ {a}_{j ( m )} = Δ n / n sin {θ}_{j} sin ( 2 {ϕ}_{j}^{-} + {φ}_{1} ) \qquad ( 8 )$$

Comparison of the above expression (8) with expression (5) confirms the validity of the method. Expression (8) provides the numerical value of the change in the threshold gain of each cavity mode m due to the introduction of s slots.

The following are examples of threshold gain distributions to describe how suppression of cavity modes neighbouring the selected mode at m=m₀ can be achieved. This guarantees stability of the peak lasing mode wavelength with temperature provided the dimensions of the device and the slot lengths and positions are accurately known. A sufficient number of slots must also be introduced in order that stability of the peak lasing mode wavelength with temperature can be guaranteed over a given temperature range of interest. An estimate of the number of slots required can be made using an expression of the form of equation (5) provided the variation of the gain with wavelength, the variation of the peak gain with temperature and the index step associated with the slots are known.

Intensity Spectrum

The peak of the gain spectrum in a semiconductor laser, γ(λ₀), is generally relatively flat, varying slowly with m near the peak as illustrated in FIG. 5(a). The position of the peak, λₘₐₓ(T), also shifts with temperature. This leads to two problems:
(i) Because the gain peak wavelength varies with temperature, the laser peak emission wavelength will also vary with temperature.
(ii) Because the gain peak is relatively flat, with gain being approximately equal to loss for many modes, the spectral purity of the laser can be insufficient for certain applications.

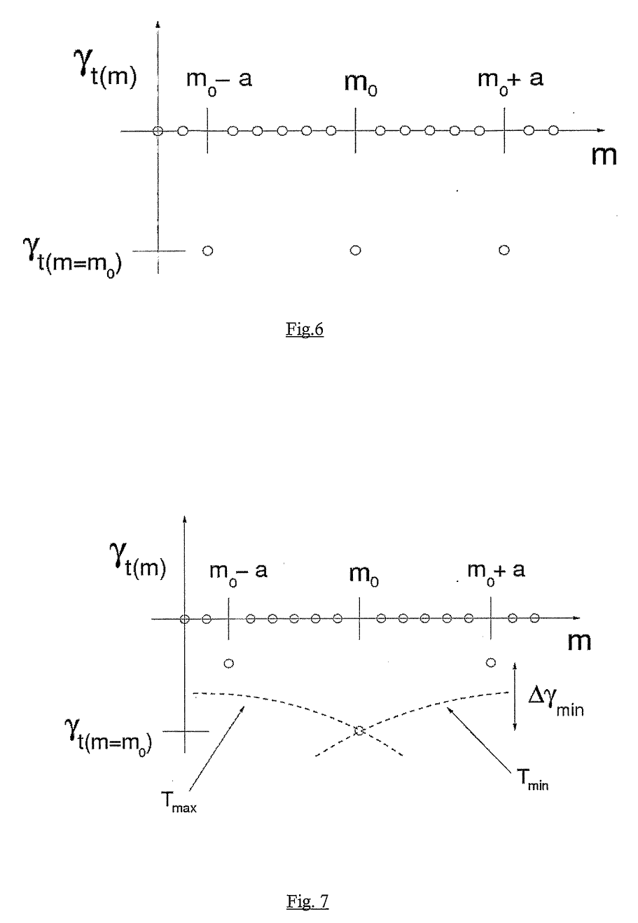

FIG. 5(b) shows how this problem can be overcome if the mirror losses associated with one mode, m₀, are sufficiently reduced compared to the losses associated with all other modes of wavelength close to that of the selected mode, m₀. Because the gain peak is of finite width, in practice, the mode m₀ need only be reduced relative to a number of neighbouring modes, a, on either side of it. This situation is illustrated in FIG. 6, where the losses are reduced at mode m₀, and equally reduced at m₀±na (n an integer), with other modes being largely unaffected by the perturbations introduced.

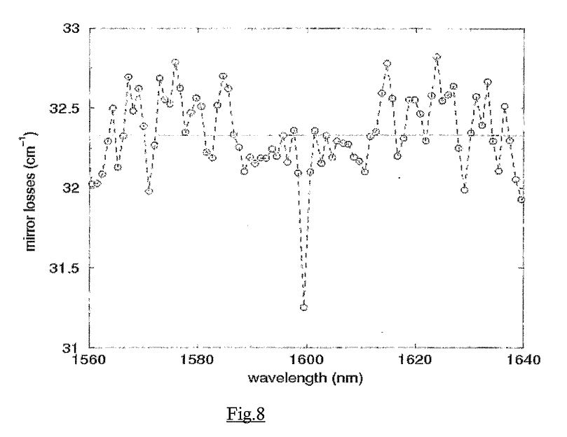

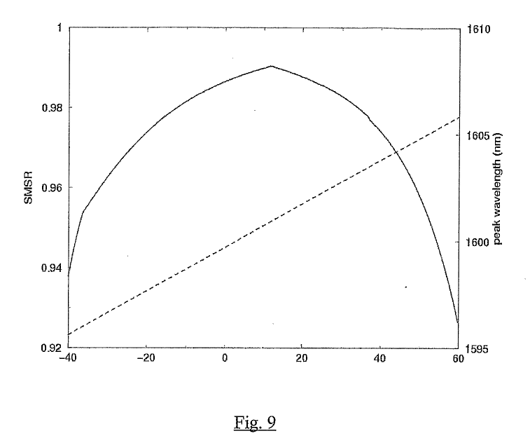

FIG. 7 illustrates another mode loss pattern which can be implemented using the method, where now the losses are reduced at mode m₀, with a weaker loss reduction at m₀±na, and with other modes being largely unaffected by the perturbations introduced. The single mode at m=m₀ now has a lower threshold than all other modes. The difference in threshold gain between the selected mode and these neighbouring modes is sufficiently large such that the peak mode is stable over a temperature range (Tₘᵢₙ, Tₘₐₓ). Provided the difference in mirror losses is larger than a minimum value, stability of the peak lasing wavelength can be guaranteed with this approach. This minimum value, Δγₘₐₓ, is depicted in FIG. 8 and will be determined by the gain spectrum variation with wavelength and by the temperature range, (Tₘᵢₙ, Tₘₐₓ), over which we require stability.

If the slots are positioned in order to select a single mode by placing the slots at the allowed positions according to the scheme above, one can show that the change of the threshold gain of the (m₀+Δm)^{th} mode, Δγₜ(m+Δm), is proportional to the following expression in the case where φ₁=φ₂=0:
cos m₀π cos ΔmπΣⱼ{r₁exp(εⱼL_{cav}αₘᵢᵣ)−r₂exp(−εⱼL_{cav}αₘᵢᵣ)}×sin θ′ⱼ sin(2εⱼm₀π)cos(2εⱼΔmπ). (9)

The method, using expression (9) in the case where φ₁=φ₂=0, includes the use of Fourier analysis in order to tailor the threshold gain spectrum to a degree such that the peak mode wavelength is predetermined and the stability of the device with changing temperature can be guaranteed.

In order to improve the spectral purity of the FP laser, an example of an ideal functional form for Δγₜ(m+Δm) would have a maximum at Δm=0 and would equal zero at all other integer values of Δm as is illustrated in FIG. 5(b). Such a function is sinc Δm, i.e.,

$$Δ {γ}_{t} ( {m}_{0} + Δ m ) = c \cdot sin c ( m - {m}_{0} ) = c \cdot \frac{sin [ π ( m - {m}_{0} ]}{π ( m - {m}_{0} )} , \qquad ( 10 )$$

where c<0 is a constant. If the modulus of the constant c is large enough, then, in principle, the stability of the device with changing temperature can be guaranteed.

This sinc gain modulation can be written as the Fourier transform of the unit rectangle or top-hat function Π(ε) (R. Bracewell, The Fourier transform and its applications, McGraw-Hill, 1965):

$$\begin{matrix}sin c ( Δ m ) = {\int }_{- ∞}^{∞} Π ( ∈ ) exp [ - ⅈ 2 π ∈ Δ m ] ⅆ ∈ \\ = {\int }_{- 1 / 2}^{1 / 2} cos [ 2 π ∈ Δ m ] ⅆ ∈ .\end{matrix} \qquad ( 11 )$$

The method uses the understanding that, in a Fabry-Pérot laser, only light at the cavity mode frequencies indexed by the integer m are of interest and that therefore, to tailor the threshold gain spectrum of the device, we consider functions defined in the wavenumber space of integers m which are based on the sinc function above with other functions used in conjunction as appropriate. We now give examples of how more complex threshold gain distributions are described and approximated according to the present invention.

In addition, cavity modes over a finite range of frequency are of interest. We therefore consider the example mirror loss in FIG. 6 and define a periodic distribution of sinc functions with spacing a cavity modes as follows:

$$p ( Δ m ) = III ( \frac{Δ m}{a} ) * sin c ( Δ m ) , \qquad ( 12 )$$

where III(x)=Σ_{-∞}^{∞}δ(x−n) and the symbol * stands for convolution. This function, p(Δm), has a Fourier transform which is proportional to III(aε)·Π(ε). This Fourier transform consists of a series of delta functions, centered at the origin, and with equal spacing a⁻¹ inside the window −½≦ε>½.

To achieve the final example mode loss pattern shown in FIG. 7, we define a Gaussian envelope function g(Δm)=exp [−πτ²(Δm)²]. The product of this function with p(Δm) is

$$( g \cdot p ) ( Δ m ) = g ( Δ m ) \cdot {\sum }_{n = - ∞}^{n = ∞} sin c ( Δ m - na ) \qquad ( 13 )$$

and has Fourier transform proportional to
Γ(ε)*III(aε)·Π(ε) (14)
where Γ(ε)=exp [−πε²/τ²] This is then simply a Gaussian broadening of each of the delta functions of the previous Fourier transform. The factor τ determines the decay of the envelope and thus the size of the gain modulation at a distance a cavity modes from the selected mode.

The present invention is based on the understanding that, in order to reproduce any given threshold gain spectrum, we must correct for the fact that the strength of the gain modulation due to a slot is determined by its proximity to the laser mirrors. We can then place a finite number of slots in order to approximately reproduce the distribution of threshold gain we desire through knowledge of the Fourier transform of the distribution. The appropriate positions for the placement of the slotted regions will be a discrete set of points as determined by the cavity mirror reflectivities and the peak modes' quarter wavelength in the cavity.

### EXAMPLE

### Determination of Parameters a and τ

The parameters that primarily determine the variation of the peak lasing mode with temperature in a FP laser are
the gain profile as a function of wavelength
the drift of the gain peak with temperature
the thermal variation of the cavity length and its effective index

If the temperature range over which we require the peak lasing mode to be stable is specified, then, using the above parameter set, we can determine a threshold gain spectrum that will ensure this stability. Our invention allows us to achieve the required spectrum of mirror losses. Based on the measured gain spectrum, and its temperature dependence, we can then determine a mode loss pattern to ensure the required stability.

The characteristics of the gain spectrum can be used to determine the choice of the parameters a and τ. We assume that the gain curve, γ(λ₀), has a parabolic variation about the peak gain position with
γ(λ₀)=−b(λₘₐₓ(T)−λ₀)²+γₘₐₓ (15)

Here λₘₐₓ(T) is the position of the gain peak, γₘₐₓ is the peak gain value at the given drive current and b describes how the gain varies with wavelength close to the peak value. It is appreciated that the parameter b is also in general a function of temperature but that for the purposes of the present example its dependence on temperature can be neglected.

As the operating temperature of the device is varied, the position of the peak gain and the free space wavelength of each cavity mode m will change (amounts Δm_{T} and Δm_{c} resp). Typical values of the parameters determining this behaviour are
drift of gain peak: 0.4 nm K⁻¹
thermal variation of index: dn/dT: 1.9×10⁻⁴K⁻¹
linear expansion coefficient: 4.6×10⁻⁶K⁻¹

We consider as an example a device which is required to be temperature stable over a temperature range of (−20° C., +80° C.). Taking room temperature to be 20° C., the device must be stable over an asymmetric interval −40K≦ΔT≦+60K. For our example device we take:
n=3.2
L_{cav}=400 μm
m₀=1600

The mode spacing at λₘ₀=1600 nm is then 1 nm and the gain peak can drift over 40 cavity modes. We therefore place the room temperature gain peak at 1596 nm and set our fundamental spacing a to be 20 modes. At the extremes of temperature variation we can show that the separation between the gain peak and our chosen cavity mode will be Δm_{T}−Δm_{c}˜14 modes apart. If we take b=5×10⁻⁴ then the difference in gain between our chosen mode and the peak will be Δγₘᵢₙ=0.1 cm⁻¹. The parameter τ is now be determined by this difference as follows:

The difference in gain between the chosen mode and the mode at spacing a is
Δγₘ_{₀}−Δγₐ=Δγₘ_{₀}·[1−g(a)]≧fΔγₘᵢₙ (16)
where Δγₘᵢₙ is the difference due to gain spectral variation and f>1 will determine the SMSR. We therefore have that

$$g ( a ) \leq 1 - \frac{f Δ {γ}_{min}}{Δ {γ}_{{m}_{0}}} \qquad ( 17 )$$

We take a=20 modes, Δγₘᵢₙ=0.1 cm⁻¹ and f=2. In this example we introduce sixteen slots with Δn=−0.02 in which case we estimate Δγₘ₀˜0.25 cm⁻¹ using expression (5). We then have τ≧0.036 in this example.

Determination of Slot Positions εⱼ

Case φ_{L}=φ_{R}=0 and |r_{L}|×|r_{R}|:

Here we illustrate how appropriate limits on ε can be derived for this case. Here the mirror reflectivites are equal and the resulting requirement that there exist a half-wavelength subcavity at the device centre then provides a natural lower limit on ε. We take
εₘᵢₙ=Lⱼ/2=(q+½)λₘ_{₀}/4nⱼ˜1.41×10⁻³ (18)

We will also account for the Gaussian broadening beyond ε=½ by setting
εₘₐₓ=½+a⁻¹ (19)

Approximating the sinh x function, which describes the amplitude variation with position, as x, our normalisation is then

$$A {\int }_{{∈}_{min}}^{{∈}_{max}} {\sum }_{n = 1}^{10} {x}^{- i} exp [ - {π ( \frac{x - n / a}{τ} )}^{2} ] ⅆ x = s \qquad ( 20 )$$

where s is the number of slots. We have not included the broadened feature at ε=0 in this example as this is responsible for a primarily d.c. component of Δε. Approximate slot positions are now determined by the relations

$$A {\int }_{{∈}_{min}}^{{∈}_{j}} {\sum }_{n = 1}^{10} {x}^{- 1} exp [ - {π ( \frac{x - n / a}{τ} )}^{2} ] ⅆ x = j - 1 / 2 , \\ j = 1 , 2 , … \qquad ( 21 )$$

These slot positions are then be adjusted in order that the quarter wave condition is met. This requires that the slots be placed on the available discrete set of points defined by the mirror reflectivities and the wavelength of the selected mode. In the case considered in this example, the correct positions correspond to the nearest fractions
αⱼ=φⱼ⁻/Σθᵢ
of the total optical path length which satisfy the appropriate phase requirement, being sin(2παⱼm₀)=±1 in this case. In this example we have placed the first slot on the right of the device center and subsequent slots on alternate sides as shown in Table 1. The integer plus one-half values in the third column ensure that sin(2παⱼm₀)=+1 according to whether the slot is placed to the left or to the right of the device center. Further minor optical path length (OPL) corrections resulting from the introduction of the slots themselves can also be taken into account. These corrections are made by generating the slot positions using an expression of the form

$${α}_{j} = \frac{{η}_{j} + {s}_{j}^{-} Δ n / n β}{1 + s Δ n / n β} . \qquad ( 22 )$$

Here s and sⱼ⁻ are the total number of slots and the number of slots to the left of slot j respectively, ηⱼ is the fraction of the cavity length for fraction of the optical path length αⱼ and β is the slot length as a fraction of the cavity length. In this example the center of the device coincides with the point where a phase slip of π/2 must be introduced into the slot pattern. The resultant threshold gain distribution in the neighbourhood of the selected mode is shown in FIG. 8.

TABLE 1
Device harmonics and adjusted slot positions: Symmetric case

| slot number | approx. ∈ⱼ | OPL fraction × m₀ | nominal position (μm) |
|---|---|---|---|
| 1 | +0.0229 | 1672.5 | 209.060 |
| 2 | −0.0347 | 1489.5 | 186.184 |
| 3 | +0.0421 | 1734.5 | 216.815 |
| 4 | −0.0487 | 1443.5 | 180.429 |
| 5 | +0.0561 | 1780.5 | 222.570 |
| 6 | −0.0674 | 1383.5 | 172.924 |
| 7 | +0.0880 | 1882.5 | 235.324 |
| 8 | −0.1023 | 1273.5 | 159.171 |
| 9 | +0.1242 | 1996.5 | 249.577 |
| 10 | −0.1509 | 1117.5 | 139.669 |
| 11 | +0.1859 | 2194.5 | 274.327 |
| 12 | −0.2192 | 899.5 | 112.420 |
| 13 | +0.2655 | 2450.5 | 306.325 |
| 14 | −0.3251 | 559.5 | 69.925 |
| 15 | +0.3955 | 2866.5 | 358.317 |
| 16 | −0.4782 | 69.5 | 8.685 |

An estimate of the SMSR below threshold and the position of the peak mode as the temperature is varied are shown in FIG. 9. As expected, no mode hopping is observed and the SMSR is greater than 90% or 10 dB throughout the temperature range. This example illustrates the potential of the present invention to improve spectral purity and to guarantee stability with temperature in semiconductor Fabry-Pérot lasers.

Experimental Data; Single Mode Case

In order to demonstrate the validity of the present invention, we have designed and fabricated a single mode laser according to the methods described above. The parameters specifying this design are as follows:
n=3.188
L_{cav}=300 μm
m₀=1236
λₘ_{₀}=1547.5 nm
r₁=0.9747
r₂=0.5292
slot number=19

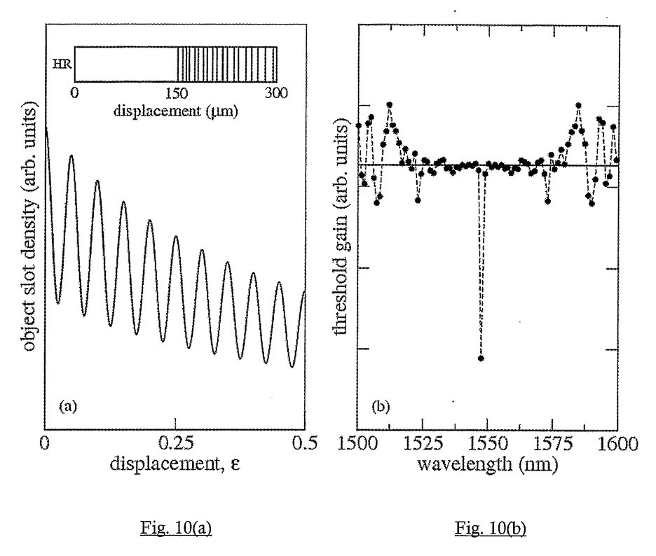

The high reflection coated on one end of the cavity, which means that slots are better placed all on the opposite side of the device center from the high reflection coating. In this way the amplitude of the modulation of the threshold gain of modes due to each slot is larger. In order to generate the approximate slot positions, the method uses equations analogous to equations (20) and (21) but with x⁻¹ replaced by
{|r₁|exp(xLα)−|r₂|exp(−xLα)}⁻¹
in the integrand. For this device we used εₘᵢₙ=0.0 and εₘₐₓ=0.5. Parameters a and τ were as in the previous example, and together with the facet reflectivities, these determine the ideal slot density distribution, plotted in FIG. 10 (a). A schematic picture of the cavity is plotted in the inset of FIG. 10 (a), while the form of the threshold gain of modes is plotted in FIG. 10 (b).

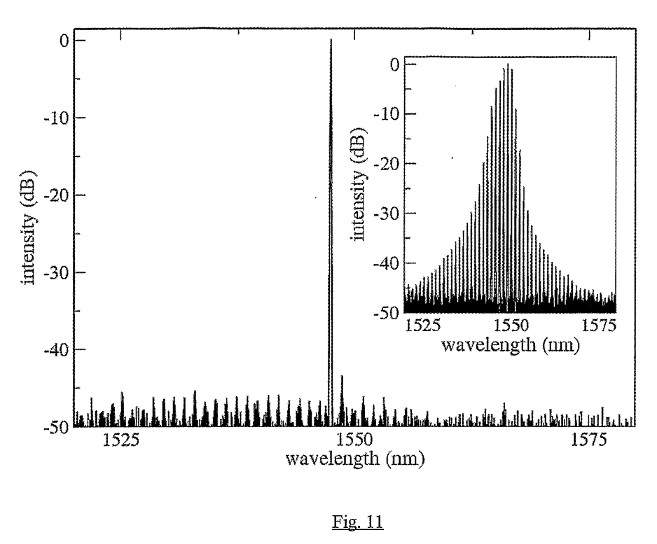

The side mode suppression at twice threshold of a laser fabricated according to this design exceeds 40 dB, as shown in FIG. 11. For comparison, an equivalent spectrum of a plain Fabry-Pérot laser without slots, fabricated on the same bar is shown in the inset of FIG. 11. This demonstrates that excellent spectral purity with a side mode suppression ratio exceeding 40 db can be achieved at a predetermined wavelength.

It will be noted from FIG. 10(a) that these slots are on the right hand side of the device center only. This is because slots further from the high reflectivity mirror will provide a larger modulation of the threshold gain (Eqn. (4)).

### MULTIMODE EXAMPLES

Two Mode Laser Cavity

We wish to select two FP modes with spacing a in preference to all others. In this case the ideal mirror loss modulation is given by
½ sinc(Δm+a/2)+½ sinc(Δm−a/2), (23)
where Δm=m−m₀, with m₀ our reference mode as before. This function has Fourier transform cos(πaε)×Π(ε). To illustrate how our method allows us to select two modes we design a laser cavity as in the previous example. In this case, to generate the approximate slot positions we use an equation, analogous to equation (20), of the form

$$A {\int }_{{∈}_{min}}^{{∈}_{j}} {\{ \vert {r}_{1} \vert exp ( x L α ) - \vert {r}_{2} \vert exp ( - x L α ) \}}^{- 1} \vert cos ( π a ∈ ) \vert ⅆ x = s \qquad ( 24 )$$

The form of the threshold gain of modes is plotted in FIG. 12, while a schematic picture of the cavity is plotted in the inset of this drawing. Note that because the Fourier transform of our object spectrum takes on negative values, we must integrate over the absolute value of the cos function in the above equation. When final slot positions are calculated, those corresponding to negative or positive Fourier components must be placed at even or odd integer values plus one half as appropriate.

Three Mode Laser Cavity

We now wish to select three FP modes with spacing a in preference to all others. As in the single mode case, we define a periodic distribution of sinc functions with spacing a cavity modes;

$$p ( Δ m ) = III ( \frac{Δ m}{a} ) * sin c ( Δ m ) .$$

The Fourier transform is proportional to
III(aε)·Π(ε).

We now take the product with an envelope function determined by the difference of two Gaussian functions
exp(πτ₁²Δm²)−Aexp(πτ₁²s²Δm²).

The Fourier transform of this composite function is then proportional to

$${\sum }_{n} \{ exp [ - {π ( \frac{∈ - n / a}{{τ}_{1}} )}^{2} ] - \frac{A}{s} exp [ - {π ( \frac{∈ - n / a}{s {τ}_{1}} )}^{2} ] \} \qquad ( 25 )$$

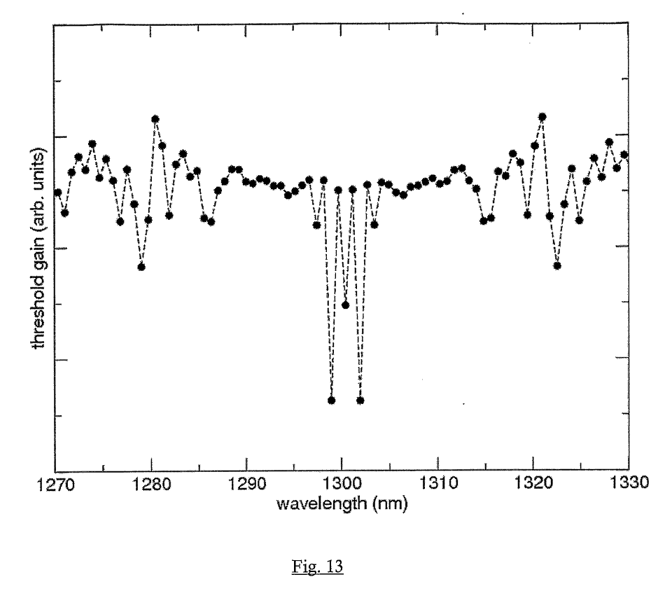

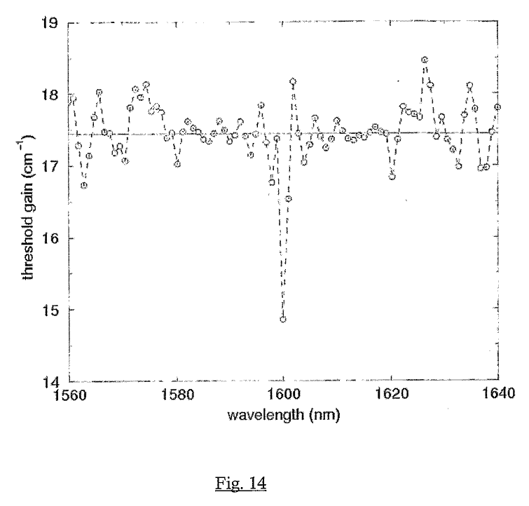

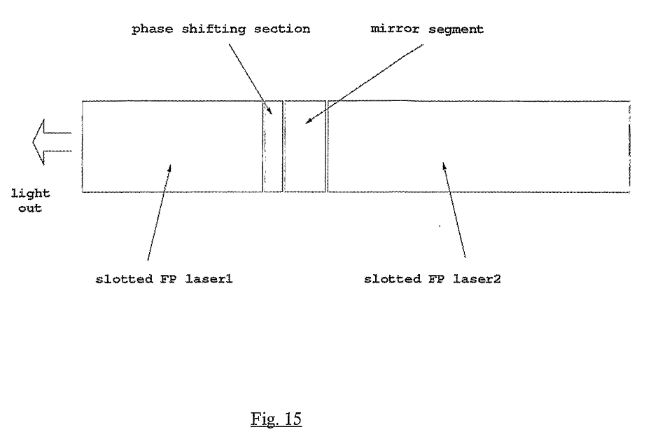

Again to illustrate how the method allows selection of three modes in this way, a laser cavity with parameters is designed. Using the appropriate equation, analogous to equation (20), and with a=2, the form of the threshold gain of modes is plotted in FIG. 13. The central mode has a larger threshold gain. Because of the variation of the material gain with wavelength in the device, this will then result in a lasing spectrum where the optical power in each of the three selected modes is equal provided the material gain variation is engineered correctly.

The difference of the two Gaussian functions increases the threshold gain at the reference mode m₀. In this way the power in the primary modes can be equal once the peak gain is positioned at mode m₀
Case φ₁≠φ₂ and |r₁|≠|r₂|:

We now return to the single mode case in order to illustrate how such a laser cavity can be designed where φ₁≠φ₂. In this general case we write the trigonometric factor,
sin(2φⱼ^{-′}+φ₁),
explicitly in terms of the slot positions and the facet phases. Again a given cavity mode m₀ is chosen and we expand as before in terms of m=m₀+Δm. The mirror loss modulation can then be expressed in terms of its even and odd components as follows:
sin(2φⱼ^{-′}+φ₁)≈cos m₀ πcos Δmπ×{v(εⱼ,m₀)cos 2πεⱼΔm+w(εⱼ,m₀)sin 2πεⱼΔm}. (26)

This expression suggests that in this general case we can seek to approximately reproduce a given mirror loss spectrum with a finite number of slots once the Fourier transform of the object spectrum and the form of the functions v(εⱼ,m₀) and w(εⱼ,m₀) are known.

To illustrate the application of the method in this asymmetric case, it will suffice to chose a given set of parameters r₁ and r₂ and to describe how the appropriate slot pattern is designed in order to select a single cavity resonance as the peak lasing mode of the device. An instructive example to treat is where the cavity has a high reflection metallic coating at one facet while the other is as cleaved. In this case we have φ₁=π, φ₂=0 and then:
v=sin 2πεⱼm₀ sin πεⱼ+cos 2πεⱼm₀ cos πεⱼ, (27)
w=cos 2πεⱼm₀ sin πεⱼ−sin 2πεⱼm₀ cos πεⱼ. (28)

Since |cosπε|>sinπε| for |ε|<¼, in order to maximize the even component of the mirror loss modulation through v while keeping the odd component to a minimum, we must place the slots such that |cos(2πεⱼm₀)|=1 for |ε|<¼ and such that |sin(2πεⱼm₀)|=1 for |ε|<¼. The higher reflection at the left facet means that the mirror loss modulation is larger for slot placed on the right of the device centre where ε>0. Thus in this case π/4 phase shift is present in the slot pattern at three-quarters of the device length.

For the example device we consider the same laser as before but with facet reflectivities given by r₁=0.95e^{iπ} and r₂=0.524. The values of τ and a are as for the previous example and here we introduce 20 slots on the right of the device centre. To generate the approximate slot positions in this case, we first integrate the product of the Fourier transform of our object spectrum with the inverse of the modulation amplitude functions, which are
[|r₁|exp(εL_{cav}αₘᵢᵣ)−|r₂|exp(−εL_{cav}αₘᵢᵣ)] cos(πε),
for 0<ε<¼, and
[|r₁|exp(εL_{cav}αₘᵢᵣ)−|r₂|exp(−εL_{cav}αₘᵢᵣ)] sin(πε),

for ¼<ε<½. The ratio of these integrals determines that 12 slots should be placed over the first interval (0<ε<¼) and 8 slots should be placed over the second interval (¼<ε<½). In each case the approximate slot positions are then generated using expressions of the type used in the first example. The resultant slot positions are given in Table 2. Note how the first 12 slots are placed such that cos(2πεⱼm₀)=1 and the final 8 slots are placed such that sin(2πεⱼm₀)=1.

TABLE 2
Device harmonics and adjusted slot positions, Asymmetric case

| slot number | approx. ∈ⱼ | OPL fraction × m₀ | nominal position (μm) |
|---|---|---|---|
| 1 | +0.0067 | 1622 | 202.678 |
| 2 | +0.0294 | 1694 | 211.682 |
| 3 | +0.0481 | 1754 | 219.186 |
| 4 | +0.0644 | 1806 | 225.691 |
| 5 | +0.0910 | 1892 | 236.444 |
| 6 | +0.1070 | 1942 | 242.699 |
| 7 | +0.1339 | 2028 | 253.452 |
| 8 | +0.1521 | 2086 | 260.707 |
| 9 | +0.1749 | 2160 | 269.960 |
| 10 | +0.1977 | 2232 | 278.964 |
| 11 | +0.2156 | 2290 | 286.219 |
| 12 | +0.2422 | 2376 | 296.972 |
| 13 | +0.2581 | 2426.5 | 303.289 |
| 14 | +0.2870 | 2518.5 | 314.792 |
| 15 | +0.3071 | 2582.5 | 322.797 |
| 16 | +0.3407 | 2690.5 | 336.299 |
| 17 | +0.3660 | 2770.5 | 346.299 |
| 18 | +0.4020 | 2886.5 | 360.804 |
| 19 | +0.4422 | 3014.5 | 376.806 |
| 20 | +0.4814 | 3140.5 | 392.557 |

The resultant threshold gain distribution in the neighbourhood of the selected mode is shown in FIG. 4. Again, excellent mode selectivity is achieved.

It will be appreciated that the invention provides a method to improve the spectral purity of a Fabry-Pérot semiconductor laser at a predetermined wavelength. The method is based on an understanding of the role of each additional feature in predetermining the peak lasing wavelength. The method achieves temperature stability, minimises the mirror losses associated with selected modes, and specifies the losses associated with a range of neighbouring modes.

Although we are primarily concerned with the optimisation of semiconductor lasers emitting near 1.3-1.5 μm for the telecomms market, our method is valid for any device where the cavity mirrors are the primary source of regenerative feedback for lasing. The additional features can in principle take any form that will provide the internal reflection and thus a modulation of the threshold gain of the cavity modes.

The method allows the efficient design and manufacture of semiconductor lasers with improved spectral purity and temperature stability, and at a predetermined wavelength but at a fraction of the cost of creating a DFB or a DBR laser. Embodiments of the present invention will also include coupled cavity devices and multi-contact devices where the distinct cavities or sections of the device have a slot pattern designed using the methods described.

A schematic diagram of a multi-section device where two slotted FP lasers are connected longitudinally is shown in FIG. 15. In this example the device includes a phase section and a mirror segment. Each section is independently contacted. In such a device the peak lasing mode wavelength can be dynamically tuned through the vernier effect. The basis for this functionality is the difference in the peak mode spacing a between the two slotted FP sections and the variation of the wavelength of these peak modes with injected carried density. The device can also incorporate further sections such as an electro-absorption modulator or an amplifying section. An advantage of the method in this case is much reduced fabrication cost as compared to devices based on, for example, sampled grating DBR lasers.

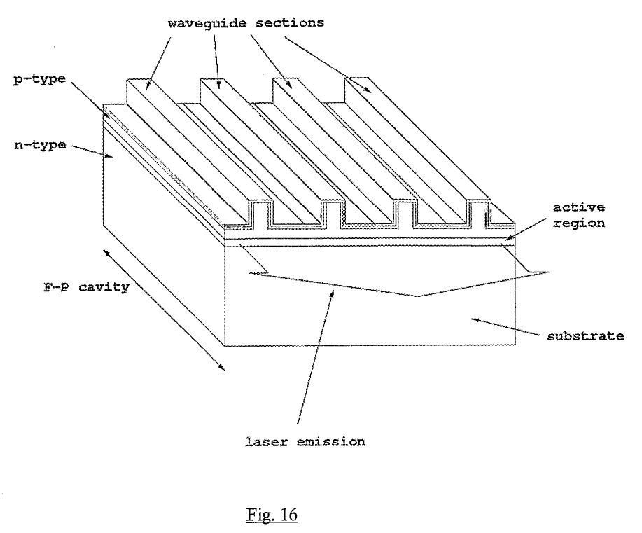

A schematic of a device where four slotted FP lasers are coupled laterally is shown in FIG. 16. Each section can be independently contacted. In such a device the individual FP modes are coupled across the device. Such devices allow for increased power output and larger modulation bandwidths. The advantage of the invention in this case is improved spectral purity as compared to devices based on plain FP lasers.

In a manufacturing method to implement the design, the slots are preferably formed at the ridge lithographic and etching stages. The invention is particularly advantageous for designing and manufacturing tailored multi-mode FP edge-emitting lasers inexpensively.

The invention is not limited to the embodiments described but may be varied in construction and detail. For example, the invention may be applied to any edge-emitting laser of the FP type. These include lasers in which the optical gain is provided by inter-band or intra-band electronic transitions. Examples are quantum cascade lasers or surface plasmon enhanced quantum cascade lasers.

The cladding may alternatively be of a metal.

In the embodiments of the invention described above the features to alter the refractive index are slots. However, different refractive index altering features may be used, such as a projection in the cladding (added matter, rather than missing matter as in the case of a slot) or a discontinuity in the cladding material. Indeed any feature which causes a discrete local change in effective refractive index in the transverse direction could be employed.

1-15. (canceled)

16. A method for designing an edge-emitting semiconductor laser device comprising a Fabry-Pérot laser cavity with mirrors for regenerative feedback for lasing, and at least one feature in the cladding between the cavity mirrors, each feature causing a local change in refractive index, the method comprising determining the locations of the features based on a relationship between feedback in sub-cavities between each feature and a cavity mirror and modulation of the threshold gain of the Fabry-Pérot modes of the cavity, and wherein the method comprises the steps of:
setting device Fabry-Pérot reference mode, cavity mirror reflectivities, number of features, and form of threshold gain modulation required;
providing a feature density function;
sampling the feature density function; and
adjusting feature positions indicated by the sampling to optimise resonant feedback magnitude.

17. The method as claimed in claim 16, wherein the feature density function is provided by multiplying the threshold modulation amplitude expression by the Fourier transform of the desired threshold gain modulation function, said feature density function being:
[|r₁|exp[εL_{cav}αₘᵢᵣ]−|r₂|exp[−εL_{cav}αₘᵢᵣ]]⁻¹|F(ε)|,
in which,
the gain is distributed uniformly along the length of the cavity,
$${α}_{mir} = \frac{1}{{L}_{cav}} log \frac{1}{\vert {r}_{1} {r}_{2} \vert}$$
are the mirror losses of an unperturbed cavity,
L_{cav} is the cavity length,
r₁ and r₂ are the mirror reflectivities
F(ε) is the Fourier transform of the threshold modulation function, and
ε=η−½, η being the position of a feature along the cavity expressed as a fraction of the total cavity length.

18. The method as claimed in claim 17, wherein the Fourier transform has positive and negative components, the positive and negative components give rise to slot positions located at even integer plus one half and odd integer plus one half multiples of the values of the quarter wavelength of light emitted at the selected mode m₀ with respect to one of the cavity mirrors and there are multiple modes in the laser spectrum.

19. The method as claimed in claim 16, wherein the feature density function sampling is determined by the total number of features to be introduced.

20. The method as claimed in claim 19, wherein the sampling is performed according to the expression:
$$A {\sum }_{n} { [ \vert {r}_{1} \vert exp [ ∈ {L}_{cav} {α}_{mir} ] - \vert {r}_{2} \vert exp [ - ∈ {L}_{cav} {α}_{mir} ] ]}^{- 1} Γ ( x - n / a ) ⅆ x = j - 1 / 2$$
in which the normalisation constant A is determined by the number of features to be introduced, which must be specified in order to sample the feature density function.

21. The method as claimed in claim 16, wherein the feature positions are adjusted so that for each feature, a short sub-cavity on one side has a length which is an odd integer multiple of quarter wavelengths of the selected mode m₀, and the longer sub-cavity on the other side has a length which is an even integer multiple of quarter wavelengths of the selected mode, provided that the change is the effective index due to a feature is negative, the mirror reflectivities are real and positive numbers, and single mode operation is desired.

22. The method as claimed in claim 16, wherein the features are slots in the cladding.

23. The method as claimed in claim 22, wherein the slots are in a cladding ridge.

24. The method of manufacturing an edge-emitting semiconductor laser device comprising a Fabry-Pérot laser cavity with mirrors for regenerative feedback for lasing, the method comprising the steps of:
designing the device in a method as claimed in claim 16, and
fabricating the device with provision of slots in a cavity ridge during lithographic and etching stages of forming the ridge.

25. The method of manufacturing an edge-emitting semiconductor laser device comprising a Fabry-Pérot laser cavity with mirrors for regenerative feedback for lasing, the method comprising the steps of, wherein the device is designed in a method as claimed in claim 18, and the device is a multi-mode laser device.

26. The edge-emitting semiconductor laser device comprising a Fabry-Pérot laser cavity with mirrors for regenerative feedback for lasing, and at least one feature in the cladding between the cavity mirrors, said feature or features being located according to a design method of claim 16.

27. The semiconductor laser device whenever produced by a method of claim 16.
